(19) United States
(12) Patent Application Publication
(10) Pub. No.: US 2026/0287052 A1
(43) Pub. Date: Sep. 24, 2026

(54) GEARBOX STRUCTURE

(71) Applicant: Delta Electronics, Inc., Taoyuan City (TW)

(72) Inventors: Chi-Wen Chung, Taoyuan City (TW); En-Yi Chu, Taoyuan City (TW); Chin-Hsiang Chen, Taoyuan City (TW)

(21) Appl. No.: 19/346,829

(22) Filed: Oct. 1, 2025

Related U.S. Application Data
(60) Provisional application No. 63/776,498, filed on Mar. 24, 2025.

(30) Foreign Application Priority Data
Jul. 22, 2025 (CN) 202511007753.X

(51) Int. Cl. F16H 57/021; F16H 1/28; F16H 57/02

(52) U.S. Cl. CPC F16H 57/021; F16H 1/28; F16H 2057/02026; F16H 2057/02034; F16H 2057/02073

(57) ABSTRACT

A gearbox structure is disclosed and includes a housing, a transmission module and a sensing module. The housing includes a first accommodation space, a second accommodation space and a partition wall. The first accommodation space and the second accommodation space are separated by the partition wall. The transmission module is arranged in the first accommodation space and includes an input gear, a planetary shaft and an output shaft. The input gear is combined with the power source, the planetary shaft includes an input-planetary gear and an output-planetary gear respectively arranged at two opposite ends, the input-planetary gear is meshed with the input gear, and the output- planetary gear is meshed with the output shaft. The sensing module includes a sensor accommodated in the second accommodation space. The sensor is disposed adjacent to the planetary shaft through the partition wall, and located between the input-planetary gear and the output-planetary gear.

### CROSS-REFERENCE TO RELATED APPLICATION

This application claims the benefit of U.S. Provisional Application No. 63/776,498 filed on Mar. 24, 2025, and entitled “GEARBOX WITH VIBRATION MONITORING AND FULL CLOSED LOOP FUNCTIONS”. This application claims priority to China Patent Application No. 202511007753.X filed on Jul. 22, 2025. The entireties of the above-mentioned patent application are incorporated herein by reference for all purposes.

### FIELD OF THE INVENTION

The present disclosure relates to a gearbox structure, and more particularly to a gearbox structure suitable for use in combination with a control unit and a power source, wherein the planetary-gear span accommodated in the housing is elongated, so that a sufficient optimized space is provided for the sensing module to be arranged in the housing relative to the transmission module, and the changes generated by the transmission module are measured accurately, thereby improving the control accuracy of the system.

### BACKGROUND OF THE INVENTION

A gearbox is a speed-changing device that achieves the speed changes by combining large gears and small gears. Different gear combinations will result in two different applications: speed increasers and speed reducers. Common reducers include planetary reducers, cycloid reducers, harmonic reducers, etc. As for the speed increaser, its common use is in the wind turbines.

The gearboxes on the current market are more compact in structure. It is no longer possible to install sensor components internally. Therefore, when the gearbox fails or is damaged, the internal gears and bearings already need to be replaced. When measuring the vibration and the temperature of the gearbox, the external sensor must be attached to the surface of the gearbox for measurement. Measurement and display methods are mostly achieved through displays and accelerometers. The displays available on the market can but used for displaying measurement data, but they are relatively large and have limited installation space. As for the accelerometers, when the reducer is running or testing, the accelerometers must be attached to different locations to measure vibration. Therefore, the vibration measurement is implemented through the matching measurement software, and the measurement time is also relatively time-consuming. Its structure and cables are relatively fragile, and its price is relatively high.

Therefore, there is a need of providing a gearbox structure suitable for use in combination with a control unit and a power source. By elongating the planetary-gear span accommodated in the housing, a sufficient optimized space is provided for the sensing module to be arranged in the housing relative to the transmission module, and the changes generated by the transmission module are measured accurately, so that the control accuracy of the system is improved, and the drawbacks encountered by the prior arts are obviated.

### SUMMARY OF THE INVENTION

An object of the present disclosure is to provide a gearbox structure suitable for use in combination with a control unit and a power source. By elongating the planetary-gear span accommodated in the housing, a sufficient optimized space is provided for the sensing module to be arranged in the housing relative to the transmission module, and the changes generated by the transmission module are measured accurately, so that the control accuracy of the system is improved.

Another object of the present disclosure is to provide a gearbox structure suitable for use in combination with a control unit and a power source. An input gear in the gearbox structure is rotated by the power source, the speed and the torque are transmitted to an output-planetary gear through an input-planetary gear of a planetary shaft, and the torque and the speed are outputted through the output shaft. Since the input-planetary gear and the output-planetary gear are connected by a connection section of the long shaft, the first accommodation space in the housing for accommodating the planetary shaft further has a sufficient space corresponding to the connection section of the long shaft in position to place an optical encoder and a magnetic encoder. The occupancy of the encoder in the first accommodation space is indirectly affected by the different specifications of the encoder. In the first accommodating space, a cylindrical roller bearing is disposed at a rear end of the output shaft and served as a support bearing of the encoder, so that the encoder is stably performed for signal feedback. Furthermore, the ingress protection (IP) ratings of the encoder installation space provided by the first accommodation space must reach IP65, and the first accommodation space must meet the requirements of the gear operating space and the encoder size. In order to achieve the feedback control, the encoder of the power source is served as the first encoder at the input end, and the encoder inside the gearbox structure is served as the second encoder to measure the output speed. After matching two of them, a full closed-loop structure is formed to improve the product performance. On the other hand, since the vibration frequency is generated during the operation of the gearbox structure, the accelerometer sensor is arranged in the second accommodation space in the housing, close to the partition wall connected to the planetary-gear support bearing, and located between the output shaft and the input shaft, so that the signal measurement and the internal temperature measurement are more accurate than that of an external measurement. Furthermore, the accelerometer sensor accommodated in the second accommodation space is served as the third sensor, and the temperature sensor accommodated in the second accommodation space is served as the fourth sensor. In case of that the internal gears of the gearbox structure do not run smoothly or the bearings are damaged, the vibration frequency is changed. By monitoring the frequency, the information is immediately transmitted to the control unit to stop the motor, so that the damage of the internal parts of the gearbox structure is reduced. The gearbox structure allows monitoring of the temperature inside the housing and the vibration frequency of the X, Y, and Z axes through the provision of the accelerometer sensor and the temperature sensor. By setting the electronic paper on an outer surface of the housing, the information can be simplified and transmitted to the electronic paper synchronously, so that the user can learn the frequency and temperature changes more directly. Certainly, the present disclosure is not limited thereto.

In accordance with an aspect of the present disclosure, a gearbox structure is provided and suitable for use in combination with a control unit and a power source. The gearbox structure includes a housing, a transmission module and a sensing module. The housing includes a first accommodation space, a second accommodation space and a partition wall, wherein the first accommodation space and the second accommodation space are separated by the partition wall. The transmission module is arranged in the first accommodation space and includes an input gear, at least one planetary shaft and an output shaft, wherein the input gear is combined with the power source, the at least one planetary shaft includes an input-planetary gear and an output-planetary gear, the input-planetary gear and the output-planetary gear are arranged at two opposite ends, respectively, the input-planetary gear is meshed with the input gear, and the output- planetary gear is meshed with the output shaft. The sensing module includes at least one sensor accommodated in the second accommodation space, wherein the at least one sensor is disposed adjacent to the at least one planetary shaft through the partition wall, and located between the input-planetary gear and the output-planetary gear.

In an embodiment, the sensing module further includes an encoder component, and the encoder component is accommodated in the first accommodation space, spatially corresponding to a rear end of the output shaft, and configured to measure an output rotation speed of the output shaft for feedback control.

In an embodiment, the encoder component includes an encoder, an encoder reading head and an encoder fixing base, wherein the encoder is connected to the rear end of the output shaft, and the encoder reading head is fixed to the encoder fixing base and spatially corresponding to the encoder, and the encoder and the encoder reading head are configured collaboratively to measure the output rotation speed of the output shaft.

In an embodiment, the gearbox structure further includes a cylindrical roller bearing disposed between the rear end of the output shaft and the encoder fixing base.

In an embodiment, the at least one sensor further includes a temperature sensor and an accelerometer sensor, and the temperature sensor and the accelerometer sensor are arranged on the partition wall and spatially corresponding to the at least one planetary shaft.

In an embodiment, the sensing module further includes a circuit board, and the circuit board is accommodated in the second accommodation space and electrically connected to the temperature sensor and the accelerometer sensor.

In an embodiment the sensing module further includes an electronic paper, and the electronic paper is disposed on an outer surface of the housing, electrically connected to the circuit board, and configured to display a corresponding information of the temperature sensor and the accelerometer sensor.

In an embodiment, the at least one planetary shaft includes a pair of planetary shafts spaced apart from each other, wherein the input gear and the output shaft are spaced apart along an axis and located between the pair of planetary shafts.

In an embodiment, a first spaced distance is formed between the input-planetary gear and the output-planetary gear, wherein the sensing module further comprises an encoder component, and the encoder component is accommodated in the first accommodation space, spatially corresponding to a rear end of the output shaft and located between the pair of planetary shafts, wherein the encoder component has an installation height and an installation width relative to the output shaft, and the installation height is less than the first spaced distance.

In an embodiment, a second spaced distance is formed between the pair of planetary shafts, and a value of multiplying the first spaced distance by the second spaced distance is greater than a gear operating space of the pair of planetary shafts.

In an embodiment, a value of multiplying the installation height by the second spaced distance is greater than 1.5 times a value of multiplying the installation height by the installation width.

In an embodiment, the gearbox structure further includes a cylindrical roller bearing disposed between a rear end of the output shaft and an encoder component.

In an embodiment, the gearbox structure further includes two tapered roller bearings disposed between two opposite ends of the at least one planetary shaft and the housing, respectively.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1 is a perspective structural view illustrating a gearbox structure combined with a control unit and a power source according to an embodiment of the present disclosure;

FIG. 2 is a perspective structural view illustrating the gearbox structure combined with the control unit and the power source according to the embodiment of the present disclosure and taken from another perspective;

FIG. 3 is a cross-sectional structural view illustrating the gearbox structure combined with the control unit and the power source according to the embodiment of the present disclosure;

FIG. 4 is an exploded view showing illustrating the gearbox structure combined with the control unit and the power source according to the embodiment of the present disclosure;

FIG. 5 is a perspective structural view illustrating the gearbox structure according to the embodiment of the present disclosure;

FIG. 6 is a perspective structural view illustrating the gearbox structure according to the embodiment of the present disclosure and taken from another perspective;

FIG. 7 is a cross-sectional structural view illustrating the gearbox structure through the sensing module according to the embodiment of the present disclosure; and

FIG. 8 is a cross-section view through the axis of the gearbox structure according to the embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “front,” “rear,” “inner,” “outer” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. When an element is referred to as being “connected,” or “coupled,” to another element, it can be directly connected or coupled to the other element or intervening elements may be present. Although the wide numerical ranges and parameters of the present disclosure are approximations, numerical values are set forth in the specific examples as precisely as possible. In addition, although the "first," "second" and the like terms in the claims be used to describe the various elements can be appreciated, these elements should not be limited by these terms, and these elements are described in the respective embodiments are used to express the different reference numerals, these terms are only used to distinguish one element from another element. For example, a first element could be termed a second element, and, similarly, a second element could be termed a first element, without departing from the scope of example embodiments. Besides, "and / or" and the like may be used herein for including any or all combinations of one or more of the associated listed items.

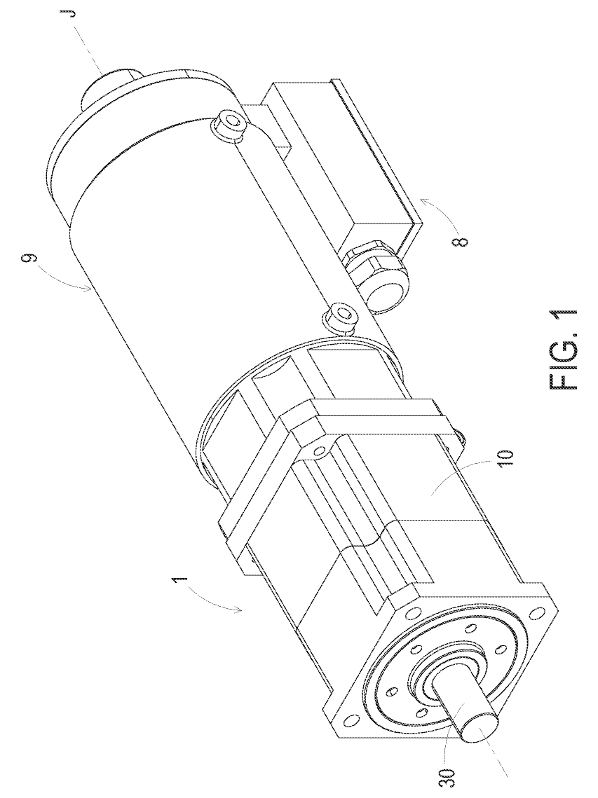

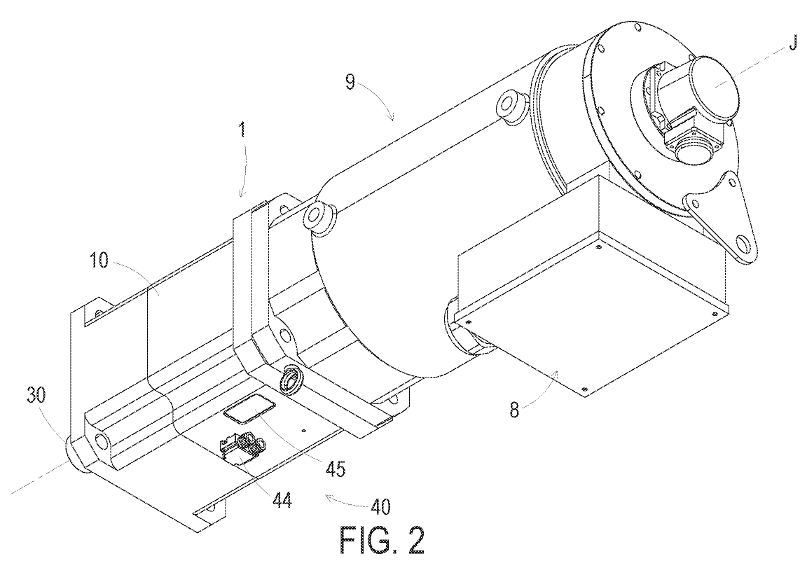

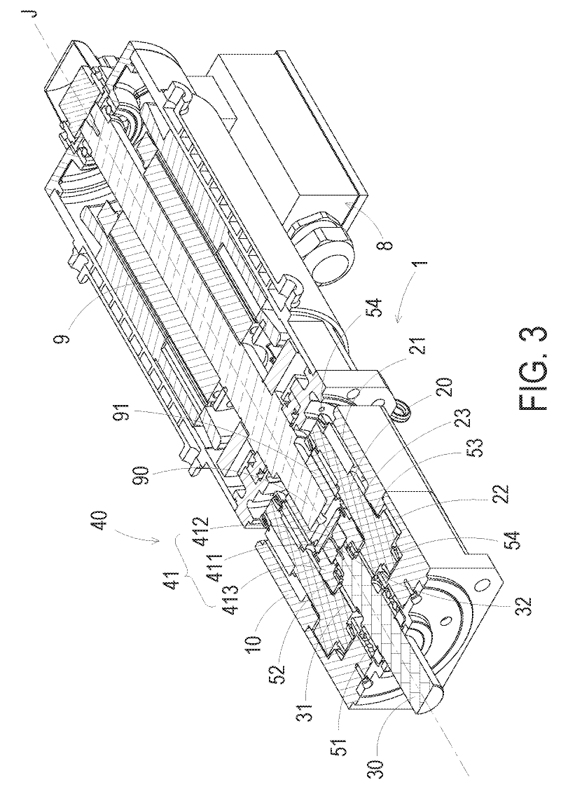

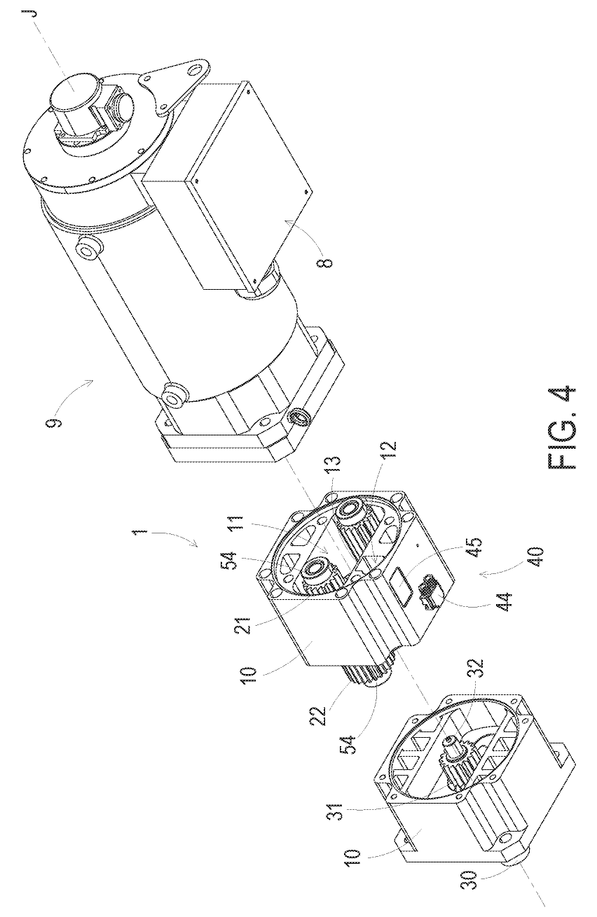

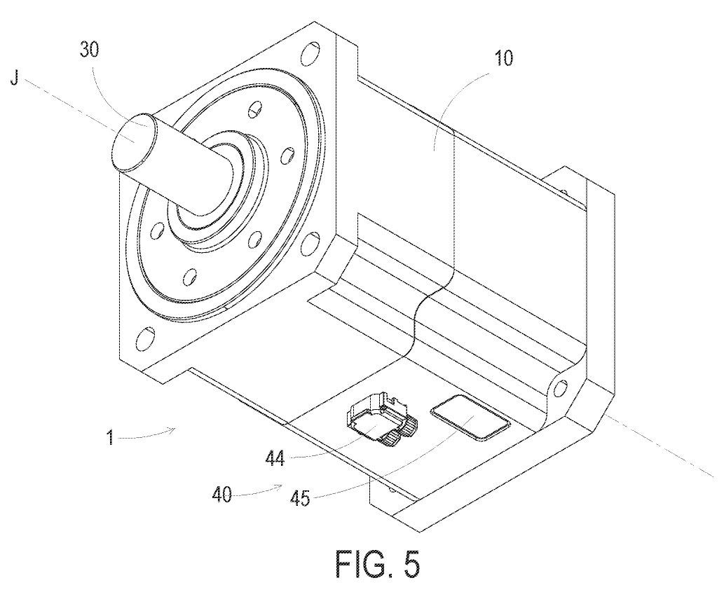

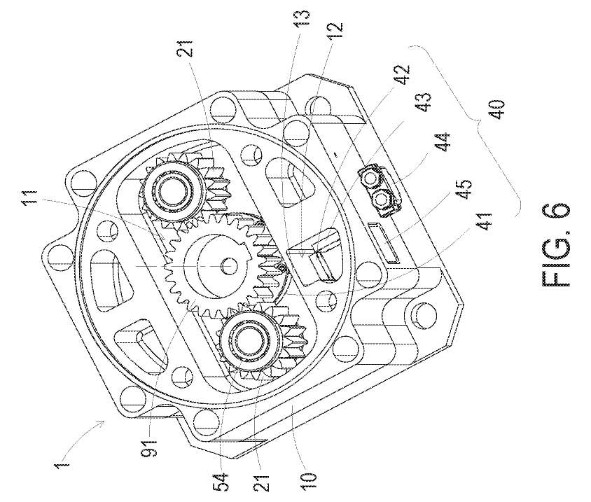

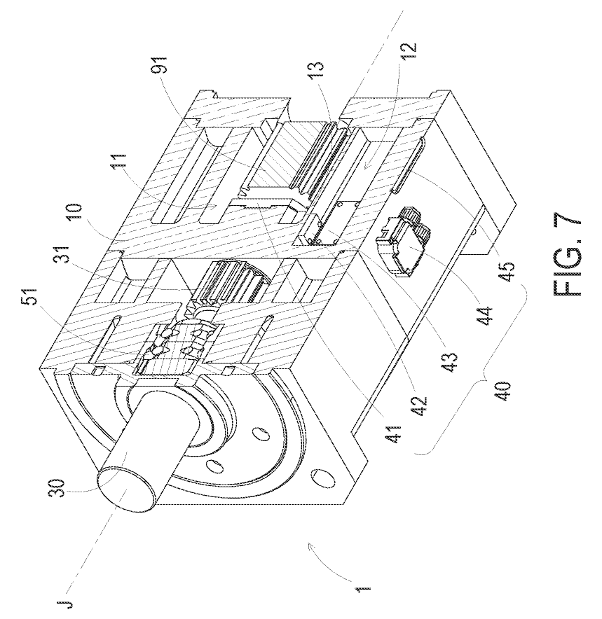

FIGS. 1 and 2 are perspective structural views illustrating a gearbox structure combined with a control unit and a power source according to an embodiment of the present disclosure. FIG. 3 is a cross-sectional structural view illustrating the gearbox structure combined with the control unit and the power source according to the embodiment of the present disclosure. FIG. 4 is an exploded view showing illustrating the gearbox structure combined with the control unit and the power source according to the embodiment of the present disclosure. FIGS. 5 and 6 are perspective structural views illustrating the gearbox structure according to the embodiment of the present disclosure. FIG. 7 is a cross-sectional structural view illustrating the gearbox structure through the sensing module according to the embodiment of the present disclosure. Please refer to FIGS. 1 to 3. The present disclosure provides a gearbox structure 1, which is suitable for use in combination with a control unit 8 and a power source 9. Preferably but not exclusively, the power source 9 is provided by an input shaft 90 of a motor. Preferably but not exclusively, the control unit 8 is integrated into a control box of the motor. Certainly, the types of the power source 9 and the control unit 8 are adjustable according to the practical requirements, and the present disclosure is not limited thereto. Please refer to FIGS. 2 to 4. In the embodiment, the gearbox structure 1 includes a housing 10, a transmission module and a sensing module 40. Preferably but not exclusively, the housing 10 is composed of a multi-piece housing component, and at least includes a first accommodation space 11, a second accommodation space 12 and a partition wall 13. In the embodiment, the first accommodation space 11 and the second accommodation space 12 are separated by the partition wall 13. The transmission module is arranged in the first accommodation space 11 and includes an input gear 91, at least one planetary shaft 20 and an output shaft 30. In the embodiment, the input gear 91 is combined with the input shaft 90 of the power source 9, and allowed to rotate about the axis J in synchronization with the input shaft 90. In the embodiment, the at least one planetary shaft 20 includes an input-planetary gear 21 and an output-planetary gear 22. The input-planetary gear 21 and the output-planetary gear 22 are arranged at two opposite ends, respectively, and connected by an extended connection section 23. The input-planetary gear 21 is spatially corresponding to the input gear 91, and meshed with the input gear 91. In addition, the output- planetary gear 22 is spatially corresponding to the output shaft 30, and meshed with an output gear 31 of the output shaft 30. When the power source 9 drives the input gear 91 to mesh with the input-planetary gear 21 through the input shaft 90, the input-planetary gear 21 and the output-planetary gear 22 of the at least one planetary shaft 20 are driven to rotate synchronously. At this time, the output-planetary gear 22 drives the output shaft 30 to output the torque and the rotation speed through the meshing action with the output gear 31, so that the power transmission of the transmission module is achieved. In the embodiment, the sensing module 40 includes at least one sensor 42. The at least one sensor 42 is accommodated in the second accommodation space 12, disposed adjacent to the at least one planetary shaft 20 through the partition wall 13, and located between the input-planetary gear 21 and the output-planetary gear 22. Since the vibration frequency is generated during the operation of the gearbox structure 1, the at least one sensor 42 is arranged in the second accommodation space 12 in the housing 10, close to the partition wall 13, and located between the input-planetary gear 21 and the output-planetary gear 22, namely the output shaft 30 and the input shaft 90, so that the signal measurement is more accurate than that measured by an external sensor.

In the embodiment, the gearbox structure 1 further includes a bevel ball bearing 51. The bevel ball bearing 51 is disposed between the output shaft 30 and the housing 10 and served as a support bearing for the output shaft 30, so that the output shaft 30 is stably rotated around the axis J. In addition, in the embodiment, the gearbox structure 1 further includes a planetary-gear support bearing 53 disposed between the at least one planetary shaft 20 and the partition wall 13 of the housing 10. In the embodiment, the gearbox structure 1 further includes two tapered roller bearings 54, which are respectively disposed between two opposite ends of the at least one planetary shaft 20 and the housing 10. The least one planetary shaft 20 allows running stably in the housing 10 through the arrangement of the planetary-gear support bearing 53 and the tapered roller bearings 54.

Furthermore, in the embodiment, in addition to the aforementioned sensor 42, the sensing module 40 further includes an encoder component 41. The encoder component 41 is accommodated in the first accommodation space 11, spatially corresponding to a rear end 32 of the output shaft 30, and configured to measure an output rotation speed of the output shaft 30 for feedback control. In the embodiment, the encoder component 41 includes an encoder 411, an encoder reading head 412 and an encoder fixing base 413. Preferably but not exclusively, the encoder 411 is connected to the rear end 32 of the output shaft 30, and the encoder reading head 412 is fixed to the encoder fixing base 413 and spatially corresponding to the encoder 411, and the encoder 411 and the encoder reading head 412 are configured collaboratively to measure the output rotation speed of the output shaft 30. In the embodiment, the gearbox structure 1 further includes a cylindrical roller bearing 52 disposed between the rear end 32 of the output shaft 30 and the encoder fixing base 413, and served as the supporting bearing of the encoder component 41, so that the encoder component 41 is stably performed for signal feedback. Preferably but not exclusively, in the embodiment, the encoder 411 includes an optical encoder and/or a magnetic encoder.

In the embodiment, the power source 9 rotates the input gear 91 in the gearbox structure 1, transmits the speed and torque to the output-planetary gear 22 through the input-planetary gear 21 of the planetary shaft 20, and then outputs the torque and the speed through the output shaft 30. Notably, since the input-planetary gear 21 and the output-planetary gear 22 are connected by a connection section 23 of the long shaft, the first accommodation space 11 in the housing 10 for accommodating the planetary shaft 20 further has a sufficient space corresponding to the connection section 23 of the long shaft in position to place the encoder component 41 constructed by the optical encoder and/or the magnetic encoder. The occupancy of the encoder component 41 in the first accommodation space 11 is indirectly affected by the different specifications of the encoder component 41. Furthermore, in the first accommodating space 11, the cylindrical roller bearing 52 is disposed at the rear end 32 of the output shaft 30 and served as the support bearing of the encoder component 41, so that the encoder component 41 can be stably performed for signal feedback. In order to achieve the feedback control, the power source 9 further includes an encoder (not shown) served as the first encoder to measure the input shaft 90, and the encoder 411 inside the gearbox structure 1 is served as the second encoder to measure the rotation speed of the output shaft 30. The combination of the two can form a full closed-loop structure and perform a closed-loop feedback control to improve the control accuracy of the system, thereby enhancing the product performance. Certainly, the present disclosure is not limited thereto.

Please refer to FIGS. 3, 4 and 6. On the other hand, in the embodiment, the at least one sensor 42 accommodated within the second accommodation space 12 further includes a temperature sensor and an accelerometer sensor integrated together. Moreover, both of the temperature sensor and the accelerometer sensor are arranged on the partition wall 13 and spatially corresponding to the at least one planetary shaft 20. Notably, since the vibration frequency is generated during the operation of the gearbox structure 1, the at least one sensor 42 including the temperature sensor and the accelerometer sensor is arranged in the second accommodation space 12 of the housing 10, close to the partition wall 13 connected to the planetary-gear support bearing 53, and located between the input-planetary gear 21 and the output-planetary gear 22, namely the output shaft 30 and the input shaft 90, so that the vibration signal measurement and the internal temperature measurement are more accurate than that of an external measurement. Therefore, in the embodiment, the accelerometer sensor of the sensor 42 accommodated in the second accommodation space 12 is served as the third sensor, and the temperature sensor of the sensor 42 accommodated in the second accommodation space 12 is served as the fourth sensor. In case of that the internal gears of the gearbox structure 1 do not run smoothly or the bearings are damaged, the vibration frequency is changed. By monitoring the frequency, the information is immediately transmitted to the control unit 8 to stop the motor of the power source 9, so that the damage of the internal parts of the gearbox structure 1 is reduced. The gearbox structure 1 allows monitoring of the temperature inside the housing 10 and the vibration frequency of the X, Y, and Z axes through the provision of the at least one sensor 42, such as the accelerometer sensor and the temperature sensor. Certainly, the present disclosure is not limited thereto.

In the embodiment, the sensing module 40 further includes a circuit board 43, and the circuit board 43 is accommodated in the second accommodation space 12 and electrically connected to the temperature sensor and the accelerometer sensor of the sensor 42. In the embodiment, the sensing module 40 further includes an encoder connector 44. Preferably but not exclusively, the encoder connector 44 is disposed on the outer surface of the housing 10 and electrically connected to the encoder component 41 accommodated in the first accommodation space 11 and the at least one sensor 42 accommodated in the second accommodation space 12. In addition, the sensing module 40 further includes an electronic paper 45, and the electronic paper 45 is disposed on an outer surface of the housing 10, electrically connected to the circuit board 43, and configured to display a corresponding information of the at least one sensor 42, such as the temperature sensor and the accelerometer sensor. By setting the electronic paper 45 on the outer surface of the housing 10, the information can be simplified and transmitted to the electronic paper 45 synchronously, so that the user can learn the frequency and temperature changes more directly. Certainly, the present disclosure is not limited thereto.

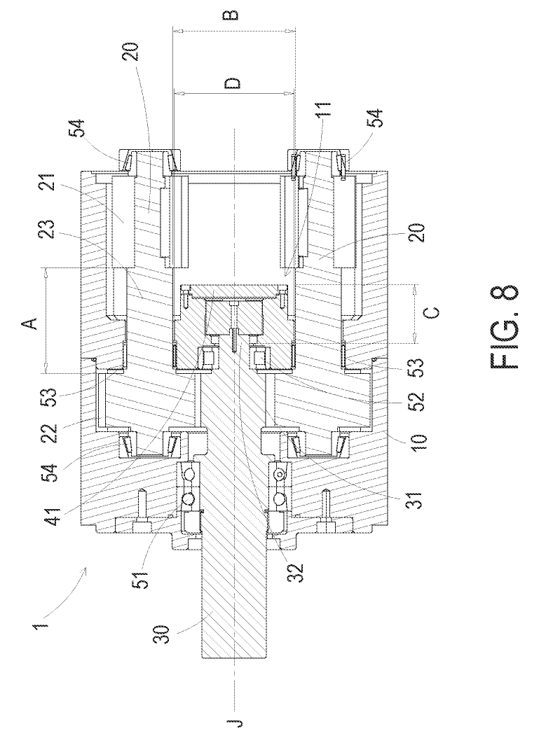

FIG. 8 is a cross-section view through the axis of the gearbox structure according to the embodiment of the present disclosure. Please refer to FIGS. 3,7, and 8. In the embodiment, the at least one planetary shaft 20 constructed in the housing 10 further includes, for example, a pair of planetary shafts 20 spaced apart from each other. In the embodiment, the input gear 90 and the output shaft 30 are spaced apart along the axis J and located between the pair of planetary shafts 20. In the embodiment, a first spaced distance A is formed between the input-planetary gear 21 and the output-planetary gear 22 in each planetary shaft 20. Furthermore, a second spaced distance B is formed between the pair of planetary shafts 20. In the embodiment, a value of multiplying the first spaced distance A by the second spaced distance B is greater than a gear operating space (for the input gear 91 and the output gear 31) of the pair of planetary shafts 20. On the other hand, since the span between the input-planetary gear 21 and the output-planetary gear 22 of the planetary shaft 20 is elongated, a sufficient optimized space is provided for the sensing module 40 to be arranged in the housing 10 relative to the transmission module. In the embodiment, the encoder component 41 of the sensing module 40 is accommodated in the first accommodation space 11, spatially corresponding to the rear end 32 of the output shaft 30 and located between the pair of planetary shafts 20. Preferably but not exclusively, the encoder component 41 has an installation height C and an installation width D relative to the rear end 32 of the output shaft 30. Moreover, the installation height C is less than the first spaced distance A and the installation width D is less than the second spaced distance B. Preferably but not exclusively, in the embodiment, a value of multiplying the installation height C by the second spaced distance B is greater than 1.5 times a value of multiplying the installation height C by the installation width D. In other embodiments, the ingress protection (IP) ratings of the encoder installation space provided by the first accommodation space 11 must reach IP65, and the first accommodation space 11 must meet the requirements of the gear operating space and the encoder size. Certainly, the present disclosure is not limited thereto.

Notably, in the embodiment, the number and the arrangement of the planetary shafts 20 constructed in the housing 10 are adjustable according to the practical requirements. The span between the input-planetary gear 21 and the output-planetary gear 22 is adjusted by the connection section, so that the space formed by the input shaft 90 and the output shaft 30 spaced apart along the axis J is conducive to the installation of the sensing module 40. Certainly, the positions of the encoder component 41, the at least one sensor 42 and the circuit board 43 of the sensing module 40 are adjustable according to the practical requirements, so as to avoid the transmission module. The present disclosure is not limited thereto and not redundantly described hereafter.

In summary, the present disclosure provides a gearbox structure suitable for use in combination with a control unit and a power source. By elongating the planetary-gear span accommodated in the housing, a sufficient optimized space is provided for the sensing module to be arranged in the housing relative to the transmission module, and the changes generated by the transmission module are measured accurately, so that the control accuracy of the system is improved. An input gear in the gearbox structure is rotated by the power source, the speed and the torque are transmitted to an output-planetary gear through an input-planetary gear of a planetary shaft, and the torque and the speed are outputted through the output shaft. Since the input-planetary gear and the output-planetary gear are connected by a connection section of the long shaft, the first accommodation space in the housing for accommodating the planetary shaft further has a sufficient space corresponding to the connection section of the long shaft in position to place an optical encoder and a magnetic encoder. The occupancy of the encoder in the first accommodation space is indirectly affected by the different specifications of the encoder. In the first accommodating space, a cylindrical roller bearing is disposed at a rear end of the output shaft and served as a support bearing of the encoder, so that the encoder is stably performed for signal feedback. Furthermore, the ingress protection (IP) ratings of the encoder installation space provided by the first accommodation space must reach IP65, and the first accommodation space must meet the requirements of the gear operating space and the encoder size. In order to achieve the feedback control, the encoder of the power source is served as the first encoder at the input end, and the encoder inside the gearbox structure is served as the second encoder to measure the output speed. After matching two of them, a full closed-loop structure is formed to improve the product performance. On the other hand, since the vibration frequency is generated during the operation of the gearbox structure, the accelerometer sensor is arranged in the second accommodation space in the housing, close to the partition wall connected to the planetary-gear support bearing, and located between the output shaft and the input shaft, so that the signal measurement and the internal temperature measurement are more accurate than that of an external measurement. Furthermore, the accelerometer sensor accommodated in the second accommodation space is served as the third sensor, and the temperature sensor accommodated in the second accommodation space is served as the fourth sensor. In case of that the internal gears of the gearbox structure do not run smoothly or the bearings are damaged, the vibration frequency is changed. By monitoring the frequency, the information is immediately transmitted to the control unit to stop the motor, so that the damage of the internal parts of the gearbox structure is reduced. The gearbox structure allows monitoring of the temperature inside the housing and the vibration frequency of the X, Y, and Z axes through the provision of the accelerometer sensor and the temperature sensor. By setting the electronic paper on an outer surface of the housing, the information can be simplified and transmitted to the electronic paper synchronously, so that the user can learn the frequency and temperature changes more directly. Certainly, the present disclosure is not limited thereto.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A gearbox structure suitable for use in combination with a control unit and a power source, comprising:
a housing comprising a first accommodation space, a second accommodation space and a partition wall, wherein the first accommodation space and the second accommodation space are separated by the partition wall;
a transmission module arranged in the first accommodation space and comprising an input gear, at least one planetary shaft and an output shaft, wherein the input gear is combined with the power source, the at least one planetary shaft comprises an input-planetary gear and an output-planetary gear, the input-planetary gear and the output-planetary gear are arranged at two opposite ends, respectively, the input-planetary gear is meshed with the input gear, and the output- planetary gear is meshed with the output shaft; and
a sensing module comprising at least one sensor accommodated in the second accommodation space, wherein the at least one sensor is disposed adjacent to the at least one planetary shaft through the partition wall, and located between the input-planetary gear and the output-planetary gear.

2. The gearbox structure according to claim 1, wherein the sensing module further comprises an encoder component, and the encoder component is accommodated in the first accommodation space, spatially corresponding to a rear end of the output shaft, and configured to measure an output rotation speed of the output shaft for feedback control.

3. The gearbox structure according to claim 2, wherein the encoder component comprises an encoder, an encoder reading head and an encoder fixing base, wherein the encoder is connected to the rear end of the output shaft, and the encoder reading head is fixed to the encoder fixing base and spatially corresponding to the encoder, and the encoder and the encoder reading head are configured collaboratively to measure the output rotation speed of the output shaft.

4. The gearbox structure according to claim 3, further comprising a cylindrical roller bearing disposed between the rear end of the output shaft and the encoder fixing base.

5. The gearbox structure according to claim 1, wherein the at least one sensor further comprises a temperature sensor and an accelerometer sensor, and the temperature sensor and the accelerometer sensor are arranged on the partition wall and spatially corresponding to the at least one planetary shaft.

6. The gearbox structure according to claim 5, wherein the sensing module further comprises a circuit board, and the circuit board is accommodated in the second accommodation space and electrically connected to the temperature sensor and the accelerometer sensor.

7. The gearbox structure according to claim 6, wherein the sensing module further comprises an electronic paper, and the electronic paper is disposed on an outer surface of the housing and electrically connected to the circuit board, and configured to display a corresponding information of the temperature sensor and the accelerometer sensor.

8. The gearbox structure according to claim 1, wherein the at least one planetary shaft comprises a pair of planetary shafts spaced apart from each other, wherein the input gear and the output shaft are spaced apart along an axis and located between the pair of planetary shafts.

9. The gearbox structure according to claim 8, wherein a first spaced distance is formed between the input-planetary gear and the output-planetary gear, wherein the sensing module further comprises an encoder component, and the encoder component is accommodated in the first accommodation space, spatially corresponding to a rear end of the output shaft and located between the pair of planetary shafts, wherein the encoder component has an installation height and an installation width relative to the output shaft, and the installation height is less than the first spaced distance.

10. The gearbox structure according to claim 9, wherein a second spaced distance is formed between the pair of planetary shafts, and a value of multiplying the first spaced distance by the second spaced distance is greater than a gear operating space of the pair of planetary shafts.

11. The gearbox structure according to claim 10, wherein a value of multiplying the installation height by the second spaced distance is greater than 1.5 times a value of multiplying the installation height by the installation width.

12. The gearbox structure according to claim 1, further comprising a cylindrical roller bearing disposed between a rear end of the output shaft and an encoder component.

13. The gearbox structure according to claim 1, further comprising two tapered roller bearings disposed between two opposite ends of the at least one planetary shaft and the housing, respectively.
